(19) United States
(12) Patent Application Publication
(10) Pub. No.: US 2006/0161541 A1
(43) Pub. Date: Jul. 20, 2006

(54) System and method for prefetching and caching query results

(75) Inventor: Andrew B. Cencini, Seattle, WA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(73) Assignee: Microsoft Corporation, Redmond, WA (US)

(21) Appl. No.: 11/037,130

(22) Filed: Jan. 19, 2005

(51) Int. Cl. G06F 17/30

(52) U.S. Cl. 707/5

(57) ABSTRACT

A system and method are provided for implementing information from an advertising system within a search system that includes a search system cache. The method may include accessing information contained within an advertising database of the advertising system, and generating search results based on the accessed information. The method may additionally include storing the accessed information and the generated search results based on the accessed information in the search system cache. A system for implementing information from an advertising system within a search system may include an advertising database within the advertising system for storing advertising information. The system may also include a caching system within the search system for extracting the information from the advertising database and storing the extracted information in a cache within the caching system.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to a system and method for caching information in order to improve the efficiency of a search engine.

### BACKGROUND OF THE INVENTION

In recent years, computer search systems have become heavily utilized and various search systems compete to provide relevant and rapid results. Since user satisfaction depends upon these factors, search system developers strive to improve search system speed and performance.

Currently, when a user submits a query to a search engine, the query is sent through a front-end server for processing. The front-end server checks the query against information stored in a cache and subsequently processes the request. The cache may either be filled by results of incoming queries or by a pre-fetching mechanism. The pre-fetching mechanism typically processes a list of queries and caches the results. The search system often determines the contents of the cache based upon a least recently used (LRU) strategy. Using the LRU strategy, the search system will maintain its cache size constraints by deleting items from the cache that have not been fetched recently.

If query results cannot be served from the cache, the search system sends the query to an index server or multiple index servers to retrieve search results. The more queries that can be served from the cache as opposed to the index server increases the capacity of a search system and decreases the amount of hardware needed to run the search system.

Thus, a solution is needed that overcomes the shortcomings and drawbacks of the prior art by providing a method that serves more queries from a cache as opposed to the index server in order to increase the capacity of a search system and decrease the amount of hardware needed to run that search system. Thus, a solution is also needed for predicting and caching results based on keywords and phrases that are most likely to be queried by a user of the search engine.

### BRIEF SUMMARY OF THE INVENTION

Embodiments of the present invention include a method for implementing information from an advertising system within a search system including a search system cache. The method includes accessing information contained within an advertising database of the advertising system. The method additionally includes generating search results based on the accessed information and storing the accessed information and the generated search results based on the accessed information in the search system cache.

Additional embodiments include a method for implementing information from an advertising system within a search system that includes a search system cache. The search system is linked to an advertising system. The method includes comparing at least one input user query term with information in or extracted from an advertising database. The method additionally includes determining if the information matches the at least one input user query term and storing search results for the input user query term in the search system, possibly with attributes indicating the entry matches information in the advertising database.

In additional embodiments, a system is provided for implementing information from an advertising system within a search system. The system includes an advertising database within the advertising system for storing advertising information. The system additionally includes a caching system within the search system for extracting the information from the advertising database and storing the extracted information in a cache within the caching system.

### BRIEF DESCRIPTION OF THE DRAWINGS

The present invention is described in detail below with reference to the attached drawings figures, wherein:

FIG. 1 is a block diagram illustrating an overview of a system in accordance with an embodiment of the invention;

FIG. 2 is block diagram illustrating a computerized environment in which embodiments of the invention may be implemented;

FIG. 3 is a block diagram illustrating a caching system in accordance with an embodiment of the invention;

FIG. 4 is a block diagram illustrating a caching system in accordance with an alternative embodiment of the invention;

FIG. 5 is a flow chart illustrating a caching method in accordance with an embodiment of the invention; and

FIG. 6 is a flow chart illustrating a caching method in accordance with an alternative embodiment of the invention.

### DETAILED DESCRIPTION OF THE INVENTION

I. System Overview

Embodiments of the invention provide a method and system for using data from an advertising system to improve the functionality of a cache utilized within a search system. More specifically, the method and system in accordance with embodiments of the invention operate in an environment including both a search system and an advertising system associated with the search system.

In the advertising system, advertisers purchase keywords and/or phrases that may be used to trigger display of their advertisement. Typically, advertisers research their selections such that their purchased sets of keywords and phrases are a strong predictor of input user queries and are thus far more likely to be queried by a user of the search engine than randomly selected keywords and phrases. Thus, the disclosed method and system extract the list of keywords and phrases from the advertising system and feed that data into the caching system of a search system in order to improve functionality of the search system.

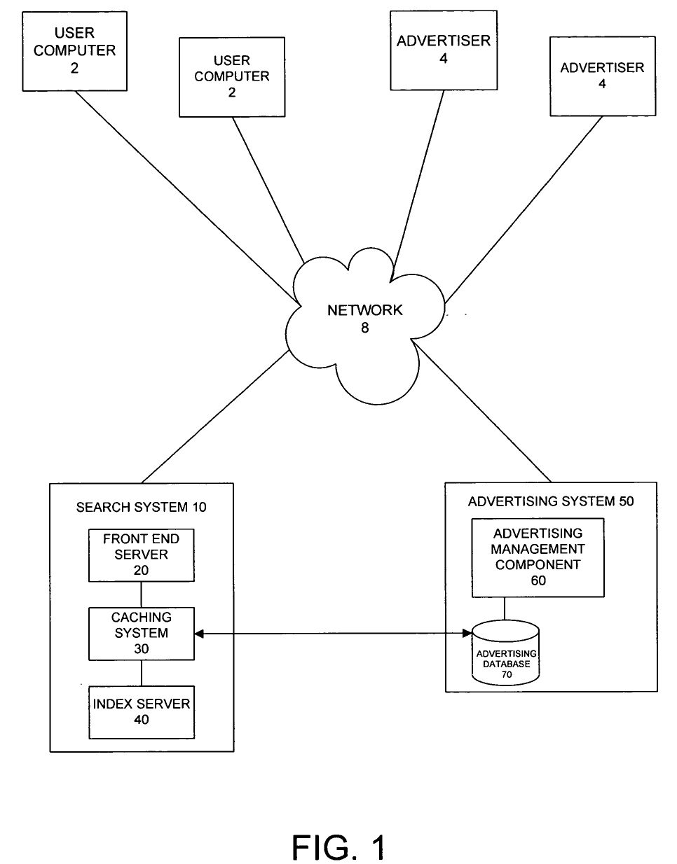

FIG. 1 illustrates a system for caching information in accordance with an embodiment of the invention. In the illustrated embodiment, user computers 2 and advertisers 4 are connected over a network 8 with a search system 10 and an advertising system 50. The search system 10 may include a front-end server 20, a caching system 30, and an index server 40. The advertising system 50 may include an advertising management component 60 and an advertising database 70. The caching system 30 maintains a connection with the advertising database 70 in order to extract advertising information. As set forth above, the advertising information stored in the advertising database 70 is a strong predictor of future user queries. Accordingly, the caching of the advertising information by the caching system 30 can increase the efficiency of the search system 10.

II. Exemplary Operating Environment

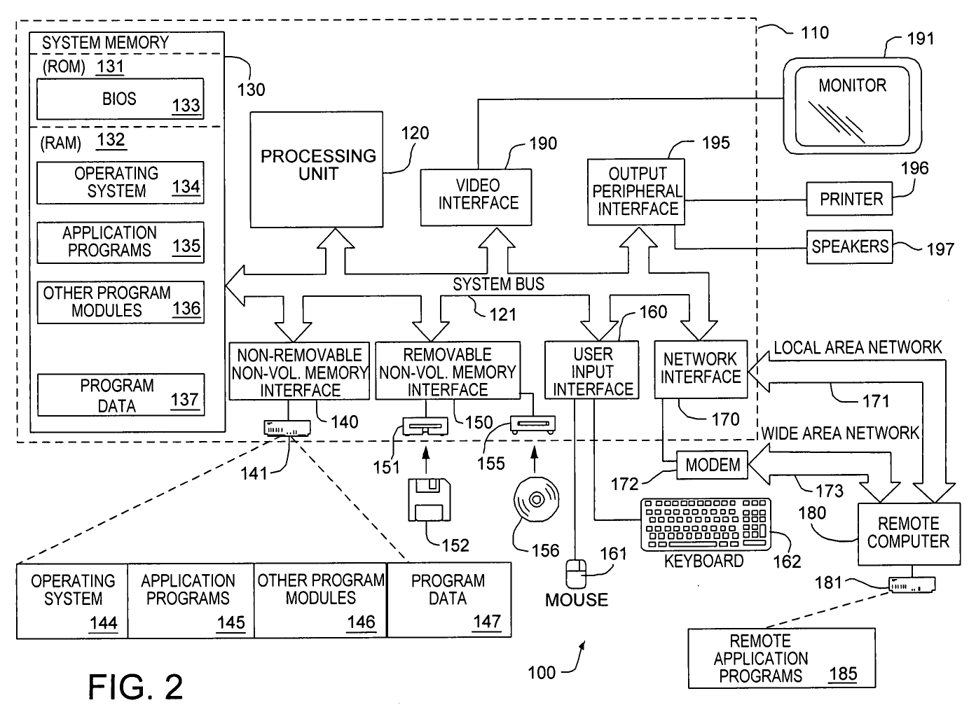

FIG. 2 illustrates an example of a suitable computing system environment 100 on which the system for caching query results may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. System and Method of the Invention

As set forth above, FIG. 1 illustrates a system for caching query results. The system includes a search system 10 connected with an advertising system 50. The search system 10 and advertising system 50 may be integrated or alternatively may be connected over a type of network as described above with respect to FIG. 2. In operation, user computers 2 access the search system 10 over the network 8 in order to enter a user query. Advertisers 4 may access the advertising system 50 to purchase keywords and phrases associated with specified constraints.

Since some search systems have begun to generate revenue by allowing advertisers to bid on specified keywords or phrases, these search systems have already incorporated advertising logic. Each time a phrase that has been bid upon is entered as a user query, an advertiser might pay a pre-set amount to have an advertisement displayed. By incorporating the information contained within the advertising system 50 into the caching system 30, the method and system are capable of efficiently and effectively increasing cache size and cache-hit ratio. Typically, the research that has already been conducted by advertisers 4 shows that the set of keywords and phrases purchased by the advertisers 4 is a strong predictor of the keywords and phrases likely to be queried by a user of the search system 10 than randomly selected keywords and phrases.

The advertising system 50 may be composed of the advertising management component 60 and the advertising database 70. The keywords and phrases purchased by the advertisers 4 may be processed by the advertising management component 60 and stored in the advertising database 70 along with specified constraints on such factors as the language or market of the user query. The advertising database 70 may additionally store advertisements for display upon that are triggered by entry of the purchased keywords and phrases within the specified constraints. The list of keywords and phrases contained within the advertising database 70 may either be updated in real time as keyword advertisements are accepted from the advertiser or asynchronously such that batches of new keywords are added or expired from the system. The advertising database 70 may additionally store tracking information for billing or other purposes, as frequently the advertiser 4 agrees to pay a set amount each time the purchased keywords and phrases generate display of the selected advertisement.

With further reference to the search system 10, upon receiving a user query, the search system 10 will send the query or a command containing the query to the advertising system 50. The search system 10 processes the query through the front-end server 20 and its caching system 30. The caching system 30 communicates with the advertising system 50 and the advertising system 50 compares the query to keywords and phrases purchased by advertisers. If the advertising management component 60 finds any matching advertisements in the advertising database 70, it sends the matching advertisements that are found back to the search system 10 for display with search results obtained through the front-end server 20.

The index server 40, which may actually include multiple servers, is shown as a portion of the search system 10, and processes the query input by the user computer 2 if the caching system 30 is unable to process the query. This would occur in instances when the results for the particular input query are not cached. The use of the index server 40 can slow down query processing given the additional work required to fetch, assemble, and return query results. Thus, the search system 10 strives to maintain an efficient caching system 30 that will have the capability to process as many input queries as possible.

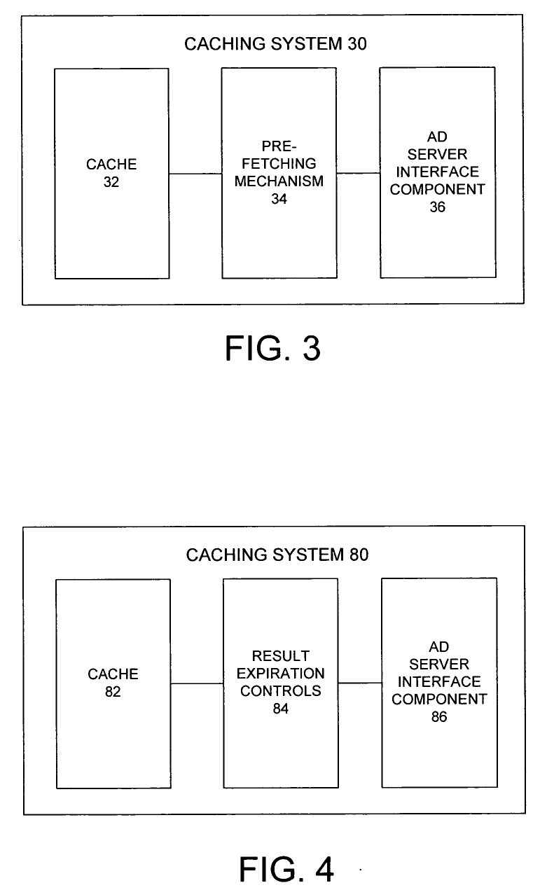

Embodiments of a caching system 30, 80 are illustrated in FIGS. 3 and 4. Generally, caching systems include components such as cache federators that are generic providers of data that may or may not be on the same physical server as the cache and any other caching system components. The cache 32, 82 may either be filled by results of incoming queries, or by some pre-fetching mechanism 34 that processes a list of queries and caches the results. Although FIGS. 3 and 4 are shown as distinct embodiments, various combinations of these embodiments may be implemented.

FIG. 3 is a block diagram illustrating an embodiment of the caching system 30. The caching system 30 may reside on one or more servers and includes a cache 32, a pre-fetching mechanism 34, and an advertisement server interface component 36. The advertisement server interface component 36 may communicate with the advertising database 70 to extract keywords and phrases and other stored information. Additionally, when a query from one of the user computers 2 matches what is stored in the advertising database 70, the advertising server interface component 36 of the caching system 30 retrieves advertisements corresponding to those keywords and phrases. The caching system 30 may implement the pre-fetching mechanism 34 to pre-fetch results for a set of queries based on the keywords and phrases. The pre-fetching mechanism 34 may operate at fixed intervals, for example as part of system maintenance. Alternatively, the pre-fetching mechanism 34 may operate over time based on user queries or incoming advertising data. In operation, the advertising server interface component 36 could extract the list of keywords, phrases, and constraints from the advertising database 70, and feed that data into the pre-fetching mechanism 34 of the caching system 30. The pre-fetching mechanism 34 may fetch the results from queries for those advertising keywords and phrases and cache the results.

FIG. 4 is a block diagram illustrating an alternative embodiment of a caching system 80. The caching system 80 may include a cache 82, result expiration controls 84, and an advertising system interface component 86. This system is particularly useful when the front-end server 20 finds and caches results upon receiving the user input query. In the displayed embodiment, the result expiration controls 84 can extend the caching period for results for advertising keywords and phrases. The result expiration controls 84 may receive an indication from the advertising interface component 86 that a processed query matches stored advertising keywords and phrases. The extension provided by the result expiration controls 84 may be automated or manual, and may be processed for a single purchased keyword or phrase or for an entire batch of keywords or phrases.

In either of the disclosed caching system embodiments, the keywords and phrases from the advertising database are exported and fed into the caching system. After acquisition, those purchased keywords and phrases may be used for pre-fetching of results, extending cache entry expiration, or other type of incorporation in to the caching system. The disclosed method and system may additionally be combined with standard LRU caching and query log analysis for pre-fetching repeated queries.

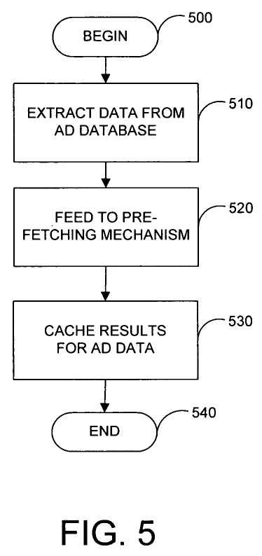

FIG. 5 is a flow chart illustrating a method for caching advertising information in accordance with an embodiment of the invention. The method begins in step 500 and the advertisement interface component 36 extracts data from the advertising database 70 in step 510. In step 520, this information is fed to the pre-fetching mechanism 34. In step 530, the pre-fetching mechanism caches results for the advertisement data in the cache 32 and the process ends in step 540. As set forth above, the caching process may be tied to the searching process in a number of ways and may be performed at intervals or on upon receipt of a search request.

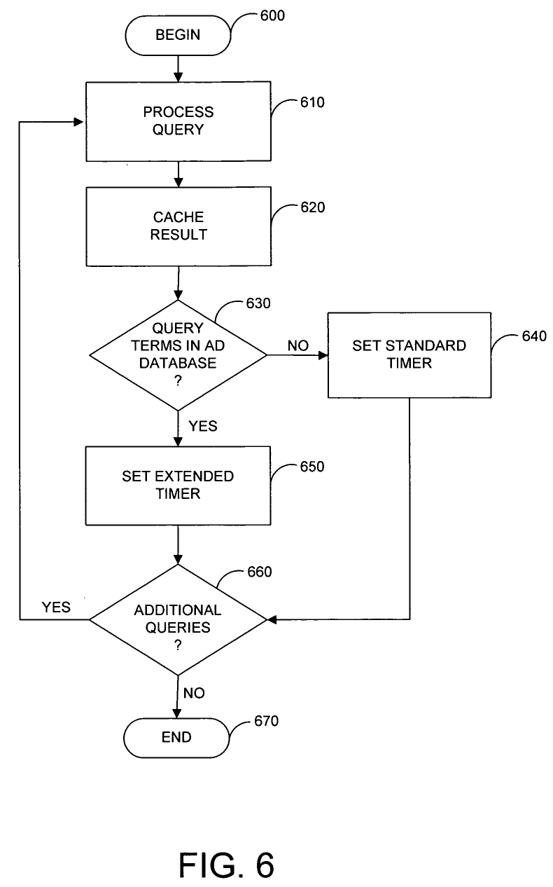

FIG. 6 illustrates an alternative embodiment of the method of the invention. The method begins in step 600 and in step 610, the search system 10 processes an input user query. In step 620, the caching system 80 caches the results of the processed query. In step 630, the advertising server interface component 86 determines if the query terms are in the advertising database 70. If the query terms are not in the advertising database 70, the result expiration controls 84 set a standard timer in step 640. However, if the query terms are found in the advertising database 70 in step 630, the result expiration controls 84 set an extended timer in step 650. Thus, advertising terms will remain in the cache 80 longer than other terms not found in the advertising database 70. In step 660, the search system 10 determines if an additional query has been made and returns to step 610 to process any additional queries. If no additional query has been made in step 660, the method ends in step 670. Although FIG. 6 illustrates a method that occurs upon receipt of each user request, the method may also be practiced at pre-selected intervals or upon the occurrence of specified events.

Thus embodiments of the system and method allow for using data from an existing component, the advertising system, to improve the functionality of another existing component, the caching system. In either of the disclosed caching system embodiments, the keywords and phrases from the advertising database are exported and fed into the caching system. After acquisition, those purchased keywords and phrases may be used for pre-fetching of results, extending cache entry expiration, or other type of incorporation in to the caching system.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for implementing information from an advertising system within a search system, the search system including a search system cache, the method comprising:
accessing information contained within an advertising database of the advertising system;
generating search results based on the accessed information; and
storing the accessed information and the generated search results based on the accessed information in the search system cache.

2. The method of claim 1, further comprising allowing advertisers to purchase information and storing the purchased information in the advertising database.

3. The method of claim 2, wherein the purchased information comprises keyword information including at least one keyword.

4. The method of claim 3, further comprising storing at least one advertisement in the advertising database associated each at least one keyword.

5. The method of claim 4, further comprising storing a constraint associated with each at least one keyword.

6. The method of claim 5, further comprising storing at least one of a language constraint and a market constraint with each at least one keyword.

7. The method of claim 3, further comprising comparing a user input query with keyword information to determine if a user input query matches the keyword information.

8. The method of claim 7, further comprising setting an extended cache expiration timer if a user input query matches the keyword information and setting a standard cache expiration timer if the keyword information does not match the user input query.

9. The method of claim 1, further comprising implementing an advertiser server interface component for extracting the accessed information from the advertising database.

10. The method of claim 9, further comprising implementing a pre-fetching mechanism for generating results for the extracted information and storing the generated results in the search system cache.

11. The method of claim 9, further comprising processing a user input query by accessing cached information and displaying an advertisement if the cached information is keyword information from the advertising database.

12. A computer readable medium storing computer executable instructions for performing the method of claim 1.

13. A method for implementing information from an advertising system within a search system, the search system including a search system cache, wherein the search system is linked to the advertising system, the method comprising:
comparing at least one input user query term with information from an advertising database;
determining if the information matches the at least one input user query term;
storing search results for the input user query term in the search system cache if the information matches.

14. The method of claim 13, further comprising allowing advertisers to purchase information and storing the purchased information in the advertising database.

15. The method of claim 14, wherein the purchased information comprises keyword information including at least one keyword.

16. The method of claim 15, further comprising storing at least one advertisement in the advertising database associated each at least one keyword.

17. The method of claim 16, further comprising storing a constraint associated with each at least one keyword.

18. The method of claim 17, further comprising storing at least one of a language constraint and a market constraint with each at least one keyword.

19. The method of claim 13, further comprising setting an extended cache expiration timer if the user input query term matches the information and caching the information while setting a standard cache expiration timer if the information does not match the user input query term.

20. The method of claim 13, further comprising implementing an advertiser server interface component for extracting the information from the advertising database.

21. The method of claim 20, further comprising implementing a pre-fetching mechanism for generating results for the extracted information and storing the generated results in the search system cache.

22. The method of claim 21, further comprising processing a user input query by accessing cached information and displaying an advertisement if the cached information is keyword information from the advertising database.

23. A system for implementing information from an advertising system within a search system, the system comprising:
an advertising database within the advertising system for storing advertising information; and
a caching system within the search system for extracting the information from the advertising database and storing the extracted information in a cache within the caching system.

24. The system of claim 23, further comprising an advertising management component for allowing advertisers to purchase information and for storing the purchased information in the advertising database.

25. The system of claim 24, wherein the purchased information comprises keyword information including at least one keyword.

26. The system of claim 25, wherein the advertising database stores at least one advertisement associated each at least one keyword.

27. The system of claim 25, further comprising a stored constraint associated with each at least one keyword.

28. The system of claim 25, further comprising at least one of a stored language constraint and a stored market constraint with each at least one keyword.

29. The system of claim 23, wherein the caching system comprises an advertising server interface component for extracting the information from the advertising database.

30. The system of claim 29, wherein the caching system further comprises a pre-fetching mechanism for generating results for stored advertising information and storing the results in the cache.

31. The system of claim 29, wherein the caching system further comprises result expiration controls for setting an extended expiration time for information in the cache extracted from the advertising database and for setting a standard expiration time for information in the cache not extracted from the advertising database.
